(19) United States
(12) Patent Application Publication
(10) Pub. No.: US 2008/0095813 A1
(43) Pub. Date: Apr. 24, 2008

(54) Insect control and elimination method and composition

(76) Inventor: Thomas Marion Kiec, Kennedale, TX (US)

Correspondence Address: ALTON W. PAYNE, 5508 GRAND LAKE, HOUSTON, TX, 77081, US

(21) Appl. No.: 11/584,228

(22) Filed: Oct. 20, 2006

(51) Int. Cl. A01N 65/00; A01N 25/00

(52) U.S. Cl. 424/405; 424/725; 424/739; 424/745; 424/757

(57) ABSTRACT

A method and composition of controlling and eliminating insects is provided. The method and composition of eliminating sophisticated chemical communication systems between insects is enhanced where insects live in functional groups, such as swarms, nests, colonies, hives, breeding pools, mounds, mating areas and other interdependent social groups. An odor neutralizer is applied directly into or in close proximity of the social group activity. The odor neutralizer chemically modifies and neutralizes the sophisticated communication chemicals known as pheromones which control sensory recognition, stimulate activity responses and facilitates communication abilities which the insects use to give commands and function as an interdependent group. The odor neutralizer is a blend of natural plant oil products. The odor neutralizer is chemically reactive with the insect pheromones, and neutralizes or modifies the pheromone. These compositions or compounds are biodegradable, nontoxic, non hazardous to the environment, adults, children, and pets. The pheromone odor neutralizer can be used in many forms including an oil-based or water-based spray, a vapor, a gel, and a cream or deposited as a solid using an absorbent carrier. The odor neutralizer is applied into the openings and the area surrounding the insect nests, so that the vapor can penetrate the proximity of the nest. Direct insect contact with the liquid or ingestion by the insect, is not necessary. The vapor creates an atmosphere that disrupts the ability of the insects to function as a group. Within 48-72 hours, the ability to communicate is disrupted, the pheromone based communications are neutralized or unrecognizable, and the social unit of insects no longer functions, thereby eliminating the nests.

### FIELD OF THE INVENTION

The present invention relates generally to a method and composition of insect control and elimination. Specifically, the present invention relates to preventing the stimulus between and among insects of the same species for one or more behavioral responses such that the insects cannot function individually or as a group and are thus eliminated.

### BACKGROUND OF THE INVENTION

There are over 900,000 species of insects in the world, representing over 85% of the animal species. There are over 3,500 species of cockroaches and almost as many mammals. Almost one third of the known insects are in the order Coleopteran, i.e., beetles. It is estimated that Insects average about 11,000,000 per acre of land. Insects survive on high rates of reproduction. Termite Queens can produce 6,000 to 7,000 eggs per day. Insects and man are in constant competition for food sources, nesting spaces and the environment. The challenge is to control or contain the intrusion of insects into our daily lives, food resources and the environment.

Numerous pesticide and insecticides both synthetic and natural are available in the market and claim to be insect “killers” or “knock down” sprays. The commercially inundated consumer believes that unless the insect immediately falls into writhing pain and discontinues any movement that the pesticide is ineffective and not working properly. Typically, the faster the “kill rate,” the more chemically active pesticide that is required to accomplish the kill. In some cases even “natural oils” in blends with chemically produced pesticides are used in high concentrations as carriers, odor modifiers and blending additives and can cause injury to the consumer and end users, if not used properly.

The material safety and environmental effects of a pesticide are often disregarded by the end user. The attitude becomes if 1 once of concentrate is good then 3 onces will certainly be better. This action leads to contamination of potable water, foods, plants, animals, children and adults. There are a rising number of cases of Acute Chemical Syndrome (“ACS”) caused by exposure over a long period of time to household chemical pesticides and insecticides. Recent medical studies are pointing to the onset of serious nervous disorders to humans due to the exposure to chemical pesticides. Synthetic pesticides are being banned by the EPA due to toxic and long term exposure effects, such as DDT, Chlordane, etc. Testing of a new pesticide may take years of research, then years testing and then years for regulatory approval by the government. Even with precautions, long-term environmental disasters can still be a danger and the toxic effects of a pesticide may ultimately be responsible for harmful effects, such as for example, extinguishing fish and wildlife.

Botanical pesticides are organic compounds composed of hydrogen, and the lighter elements with electrons in the p-orbital. These include carbon, nitrogen oxygen, phosphorus and sulphur compounds. Such botanical pesticides are natural oils distilled from plants. The botanical pesticides are not like the chemically modified pesticides which tend to form d-orbital compounds which form ionic bonds and when combined with heavy metals are often toxic. Botanical pesticides have multiple effects on insects depending on (1) chemical concentration (2) direct or indirect contact with the insect and (3) physiological effects on the insect upon contact with the liquid.

Much of the common thoughts on natural or organic pesticides are vague about the physiological effects of natural pesticides versus chemically processed pesticides. The chemical pesticides are synthesized compounds for extremely quick kill upon contact or ingestion. However natural oils are not the quick kill solutions to which the marketplace has grown accustomed. The attitude that prevails is to spray the insect watch it die and clean up the remains.

In the case of natural pesticides, the general adverse theories focus that since the natural products exist in nature, animal bodies are more likely to break down the compounds that exist in nature versus chemically modified pesticides that do not exist in nature. Organisms are more likely to deal with the compounds similar to those they encounter everyday. Most botanicals are digested by some organism, and chemically breakdown when oxidized by prolonged exposure to heat, oxygen or sunlight. In general botanicals are regarded as ineffective and poor when used to “kill” or “knock down” insects.

Much work has been done by inventors and companies using natural oils mixed with synthesized pesticides in an oil carrier to reduce the concentration of hazardous pesticides. Their focus is to create neurological effects upon insect causing the “quick kill” and “knock-down” type killers. Their effectiveness in the market is limited to mainly household use on visible insect activity. There are still issues of overpowering odors, cost effectiveness because of the high concentrations of the natural oils that are required to produce the results, application issues of direct insect contact with the liquid and consumer health and safety issues.

Primary pheromones are natural hydrocarbon chemicals produced by insects that control the activity, development, reproduction and survival of the colony. As far back as the 1870's, Joseph A. Lintner suggested that chemical scents emitted by insects could be used to control insect pests. (McBride, et al., U.S. Pat. No. 6,898,896). Pheromones used in social insect communication are highly volatile organic compounds and require the use of mass spectroscopy and gas chromatography in identification and defining chemical structure. In 1978, the first pheromone was registered in the United States for commercial use in mating disruption. In the 1990's chemically produced pheromones were used for mating disruption and the effective eliminated of insect damage in various applications. However, pheromones are very sight and insect specific. They may differ minutely from area to area based on local food sources, the surrounding environment, average temperature, moisture, ground and airborne mineral and hydrocarbon sources. Pheromones are costly to synthesize in significant quantities, and insects can detect and not recognize or respond to the synthetic compounds.

There have been comprehensive research studies over the last 30 years trying to isolate the chemical composition of pheromones. However, finding and isolating the chemical composition of such pheromones is a difficult task. They are produced in extremely small quantities by the insects and amounts of certain pheromones may even distinguish task orientation in the group. Typical values produced by insects can be measured in values between 5 micromoles and several pico-moles (one trillionth of a mole). Over 70 different distinct endocrine glands, typically the source of the pheromones, can be distinguished in social insects, for example, at least 45 in ants, 21 in bees, 14 in wasps and 11 in termites, etc. Research has shown that artificial pheromones do not always produce results due to other factors such as insect diet and localized digestive and other chemical compounds found in nature and consumed by the insects. Subtle differences due to the local environment may cause chemical modifications to the pheromones. Pheromones may also vary from insect species to insect species. Therefore, several mixtures will be needed for different groups such as, one for ants, and different mixtures for flying insects (bees, wasps, moths, etc.), and even different mixtures for cycles of growth, larvae, pupil or adult.

The group nest is a virtual vapor soup of highly volatile organic compounds, typically in the family of n-alkanes. The insect's social functional commands are disseminated into this nesting atmosphere directing the occupants to function as a group. The factors that regulate the tasks are documents as cuticular hydrocarbons, (CHCs), juvenile hormones (JHs) and ecdysteroids. Research has been done on how these chemicals influence the nest mates' identification, signaling and behavioral patterns.

As a specific example, the detection of 30 molecules of a pheromone can prompt a response in a cockroach. Thus, from a pest management standpoint, pheromones are a critical key to manipulating insect behavior in a nesting environment. Once the pheromones have reacted or are changed into non-recognizable chemical compounds then the behavior of the insect can be controlled or eliminated.

There are various pheromones used to give different commands to the colony. For example there are “alarm” chemicals produced by the guard insects to alert the colony members to dangers from intruders and come to the aid of the defenders. The swarming actions of bees, wasps, ants, and the like upon the mound or nests being disturbed is an example of pheromone-initiated behavior. Also linked to similar pheromones are the recognition of “friend or foes” in the proximity or by chance meeting. They will either recognize the nest mate or identify any non-member. At that point they may take the “Fight or Flight” instinct possibly emitting the “alarm” pheromone.

In the search for food for the colony there are specific “follow me trails” that lead nest mates to food sources for the colony. For example, an ant that has discovered a food source will go back to the colony leaving a trail of pheromones that will lead other workers to the source. Mass spectroscopy has identified complex compounds identified as methyl anthranilate and methyl noctinate as two “follow me” chemicals in a select species of ants.

The queens of the colony will give pheromone related commands to feed her, chamber the new eggs, feed the larvae, find a mate to fertilize her, destroy competing queens in the colony. These chemicals commands are the way insects function as a social group. If the dominant chemical pheromones can be disrupted, the colony would be in complete disruption and it would cease to function, thereby eliminating the queen and the colony. Individual insects could not identify food sources, a mate or be aware of their surroundings.

To totally disrupt the colony one must deal with all of the pheromone compounds and form an environment of pheromone void, reacted, modified or disguised odors as to make it unrecognizable to the insects. Odor neutralizers are a combination of natural, organic chemicals which work through the following chemical processes.

Adsorption: Molecules of the pheromone odor compound will adhere to the neutralizer molecule. After the reaction the adsorbed molecule is now part of a larger molecule with significantly lower odor or no odor at all.

Absorption: Molecules of the pheromone odor will be dissolved into the odor neutralizer. These highly volatile organic compounds are in a vapor or gas state. When in contact with the neutralizer, they dissolve and become a new non odorous compound. “Zwaademaker pairing”: Certain pairs of molecules that have a neutralizing effect on each other. Each of them has a distinct odor but when combined in the vapor state, both become unrecognizable by a canceling effect. Also, important is the fact that a small amount of the neutralizer can chemically pair with a significantly greater amount of odor due to the highly active multiple pairing sights, building longer chains of the neutralized chemical compound.

Combination: These are pheromone odors and neutralizers that chemically react to form totally different compounds. Organic chemicals in particular can dramatically change odor when they are combined to form new compounds. These compounds not only have a different chemical structure but they also have new physical and chemical properties, possibly, absorbing, adsorbing or oxidizing additional pheromone compounds. In applications where heat is added, these highly volatile compounds react extremely fast.

Oxidation: A reaction is created between the odor neutralizer, the pheromone, and available oxygen and hydrogen in the air. Enhanced with the natural heat these are vapor phase reactions that break down the compounds into safe biodegradable, non-toxic, non-hazardous compounds.

It is well known in the organic growing community that certain plant oils such as garlic can be used to reduce the number of insects intruding into gardens because of its taste when sprayed on plant leaves. It has a direct effect on the feeding cycle of insects, causing them to search elsewhere for food, but not eliminating the insect or the colony source.

Certain combinations of pesticides and plant oils have been used to create a physical effect of interfering with the respiratory cycles of certain insects, depriving them of oxygen and eventual expiration. Some of the “natural essential oils” are ingested or penetrate the insect exoskeleton causing neurological damage and sudden death. (Bessett, et al., U.S. Pat. No. 6,372,803). However, this requires direct contact with the insect and a complete coating of the insect by the oil. These are known as “knock down” or contact sprays. In addition, these natural oils must be at a concentration of 0.01% to 30% to be effective in extinguishing the insect. (Bessette, et al., U.S. Pat. No. 6,713,518). In U.S. Pat. No. 6,713,518, the inventor claims that values below this threshold have no detrimental effect on the insect, and there are no effects on the insects that are not directly contacted by the solution. (Bessett, et al., U.S. Pat. No. 6,376,556). Even in the event that a drenched insect returns to the colony or nest, there are no effects on the surrounding insects unless there is direct contact with the pesticide. Even then there must be a lethal dose of the liquid pesticide.

While 0.01% seems like a small concentration, it is not necessary to use that amount to effect the chemical communications between insects. The threshold concentration for the interruption of pheromone communication is a range of at least 10 to 100 times below, the range of contact insecticides. It does not require direct contact with the insect. It requires a vapor reaction between the pheromone vapor and the odor neutralizer vapor in the nest or between insects. The solutions and vapors are applied in such a manner as to be effective in penetrating the nest and reacting with the pheromones and extinguishing the group from functioning socially and affect the growth of the nest.

Colonies are protected underground well below the surface and the area that a spray can penetrate. The average size of an insect colony may range from 15,000 to 50,000 members before the colony needs to separate to survive. The world's largest single ant colony runs from Northern Italy across the mountains to France.

A current method of colony penetration is to use baits, loaded with pesticides that are carried deep into the mound to kill the queen upon consumption of the bait. When the bait method works, the colony looses its queen. They select a new queen and move the mound to a new location with the new queen in tow.

It is, therefore, a feature of the present invention to provide a method and composition of insect control and elimination that is safe and effective.

A feature of the present invention is to provide a method and composition of insect control and elimination that eliminates the pest.

Another feature of the present invention is to provide a method and composition of insect control and elimination that completely eliminates its domicile of the pest.

Another feature of the present invention is to provide a method and composition of insect control and elimination that can be used in very small dose rates.

Another feature of the present invention is to provide a method and composition of insect control and elimination that is environmentally friendly.

Yet another feature of the invention is to provide a method and composition of insect control and elimination that is biodegradable.

Still another feature of the present invention is utilizing a method and composition of insect control and elimination that can be used in small quantities.

Another feature of the present invention is to provide a method and composition of insect control and elimination that is safe to the consumer even if the consumer does not use the product as directed.

Additional features and advantages of the invention will be set forth in part in the description which follows, and in part will become apparent from the description, or may be learned by practice of the invention. The features and advantages of the invention may be realized by means of the combinations and steps particularly pointed out in the appended claims.

### SUMMARY OF THE INVENTION

To achieve the foregoing objects, features, and advantages and in accordance with the purpose of the invention as embodied and broadly described herein a method and composition of insect control and elimination is provided. In one embodiment, a method for the control and elimination of insects having sophisticated chemical communication odor systems is provided. The insects tend to live in a group with specific insects performing specific functions within the group pursuant to the communication between and among the insects. The method comprises determining a plant oil that has a detrimental effect on the sophisticated chemical communication odor system of the insects to be controlled and eliminated. Then, formulating an odor neutralizer comprising the selected plant oil. And, determining the total volume of odor neutralizer needed to react with the insect equivalent volume of communication chemicals in the insect group to be controlled and eliminated. And thereafter, applying the neutralizer to the insect group to be controlled. The sophisticated chemical communication odor systems of the insects are destroyed, the insects are no longer able to communicate, the coordination between the insects is no longer possible, the insects cease to function as a group, and the group is eliminated.

A composition for eliminating sophisticated chemical communication systems between insects, generally, resulting in the elimination of the insects comprising a range of 0.001-100 parts cinnamon oil, a range of 0.001-100 parts vanilla oil, a range of 0.001-100 parts wintergreen oil, a range of 0.001-100 parts licorice root oil, a range of 0.001-100 parts salvia oil, a range of 0-100 parts sodium lauryl sulfonate, and a range of 0-10,000 parts liquid chosen from the group of water and oil.

A composition for eliminating sophisticated chemical communication systems between insects, generally, and ants and termites, specifically, resulting in the elimination of the insects comprising a range of 0.001-100 parts cinnamon oil, a range of 0.001-100 parts vanilla oil, a range of 0.001-100 parts wintergreen oil, a range of 0-100 Tween, a range of 0-100 sodium lauryl sulfonate, and a range of 0-10,000 parts liquid chosen from the group of water and oil.

A composition for eliminating sophisticated chemical communication systems between insects, generally, and ants, termites grasshoppers and crickets, specifically, resulting in the elimination of the insects comprising a range of 0.001-100 parts No-Scent, a range of 0.001-100 parts Natron, a range of 0.001-100 parts wintergreen oil, a range of 0-100 parts Tween, a range of 0-100 parts sodium lauryl sulfonate, and a range of 0-10,000 parts liquid chosen from the group of water and oil.

A composition for eliminating sophisticated chemical communication systems between insects, generally, and wasps and bees, specifically, resulting in the elimination of the insects comprising a range of 0.001-100 parts cinnamon oil, a range of 0.001-100 parts wintergreen oil, a range of 0.001-100 parts camphor oil, a range of 0.001-100 parts spearmint oil, a range of 0.001-100 parts lemongrass oil, a range of 0-100 parts Tween, a range of 0-100 parts sodium lauryl sulfonate, and a range of 0-10,000 parts liquid chosen from the group of water and oil.

A composition for eliminating sophisticated chemical communication systems between insects, generally, and mosquitoes, specifically, resulting in the elimination of the insects comprising a range of 0.001-100 parts lavender oil, a range of 0.001-100 parts eucalyptus oil, a range of 0.001-100 parts camphor oil, a range of 0.001-100 parts vanilla oil, a range of 0-100 parts Tween, a range of 0-100 parts sodium lauryl sulfonate, and a range of 0-10,000 parts liquid chosen from the group of water and oil.

A composition for eliminating sophisticated chemical communication systems between insects, generally, and mosquitoes, specifically, resulting in the elimination of the insects comprising a range of 0.001-100 parts lemon oil, a range of 0.001-100 parts orange oil, a range of 0.001-100 parts cinnamon oil, a range of 0.001-100 parts clove oil, a range of 0.001-100 parts pennyroyal oil, a range of 0.001-100 parts tansy oil, and a range of 0-10,000 parts liquid chosen from the group of water and oil.

A composition for eliminating sophisticated chemical communication systems between insects, generally, and spiders, specifically, resulting in the elimination of the insects comprising a range of 0.001-100 parts wintergreen oil, a range of 0.001-100 parts eugenol, a range of 0.001-100 parts cinnamon oil, a range of 0.001-100 parts vanilla oil, a range of 0-100 parts Tween, a range of 0-100 parts sodium lauryl sulfonate, and a range of 0-10,000 parts liquid chosen from the group of water and oil.

A composition for eliminating sophisticated chemical communication systems between insects, generally, and fleas, specifically, resulting in the elimination of the insects comprising a range of 0.001-100 parts cinnamon oil, a range of 0.001-100 parts licorice root, a range of 0.001-100 parts salvia, a range of 0.001-100 parts wintergreen oil, a range of 0-100 parts sodium lauryl sulfonate, and a range of 0-10,000 parts of a liquid chosen from the group of water and oil.

A composition for eliminating sophisticated chemical communication systems between insects, generally, resulting in the elimination of the insects comprising a mixture of a range of 0.001-100 parts Odorcide, and a range of 0-10,000 parts of a liquid chosen from the group of water and oil.

A composition for eliminating sophisticated chemical communication systems between insects, generally, resulting in the elimination of the insects comprising a mixture of a planioil, a surfactant, and a liquid chosen from the group of water and oil such that the mixture is a clear and dispersed solution.

A composition for eliminating sophisticated chemical communication systems between insects, generally, resulting in the elimination of the insects comprising a mixture of a plant oil, a surfactant, and a liquid chosen from the group of water and oil such that the mixture is a clear and dispersed solution created by the steps of combining the surfactant with the plant oil to form a surfactant/oil mixture, and combining the liquid chosen from the group of water and oil with the surfactant/oil mixture to form the composition for eliminating sophisticated chemical communication systems between insects.

### BRIEF DESCRIPTION OF THE DRAWINGS

The accompanying drawings which are incorporated in and constitute a part of the specification, illustrate a preferred embodiment of the invention and together with the general description of the invention given above and the detailed description of the preferred embodiment given below, serve to explain the principles of the invention.

FIG. 1 is a flow chart of a preferred embodiment of an insect control and elimination method encompassed by the present invention.

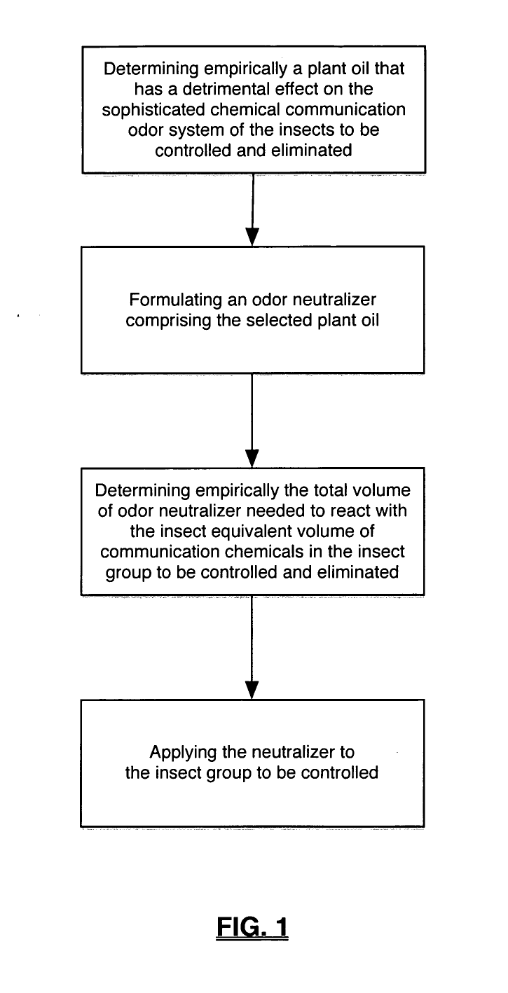

FIG. 2 is a flow chart of another preferred embodiment of an insect control and elimination method encompassed by the present invention.

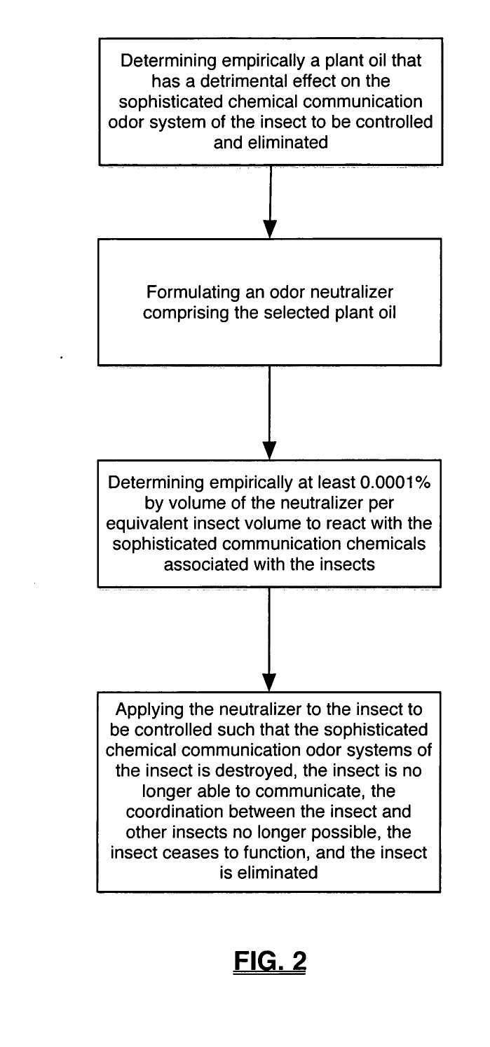

FIG. 3 is a flow chart of a preferred embodiment of the insect control and elimination composition encompassed by the present invention for use with insects generally.

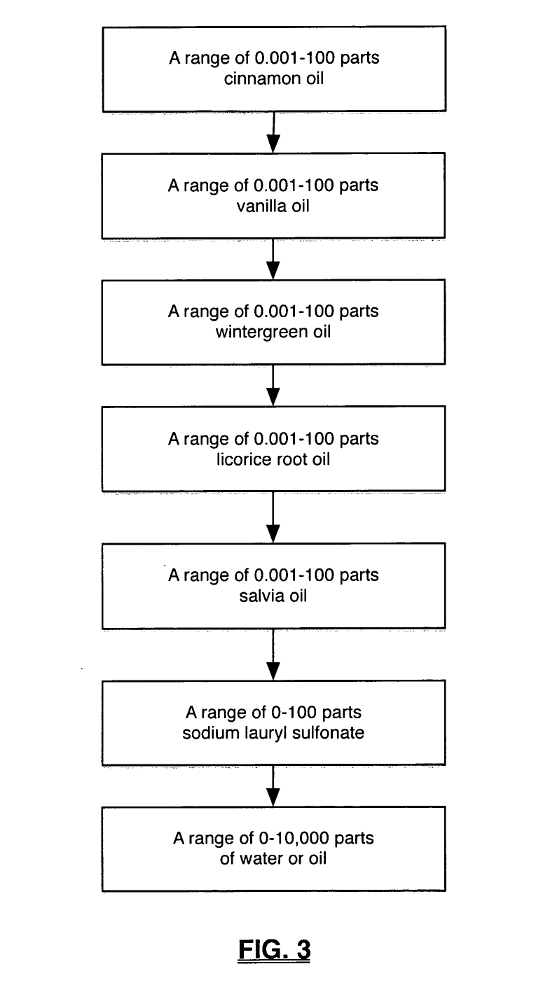

FIG. 4 is a flow chart of a preferred embodiment of the insect control and elimination composition encompassed by the present invention for use with insects generally, and ants and termites specifically.

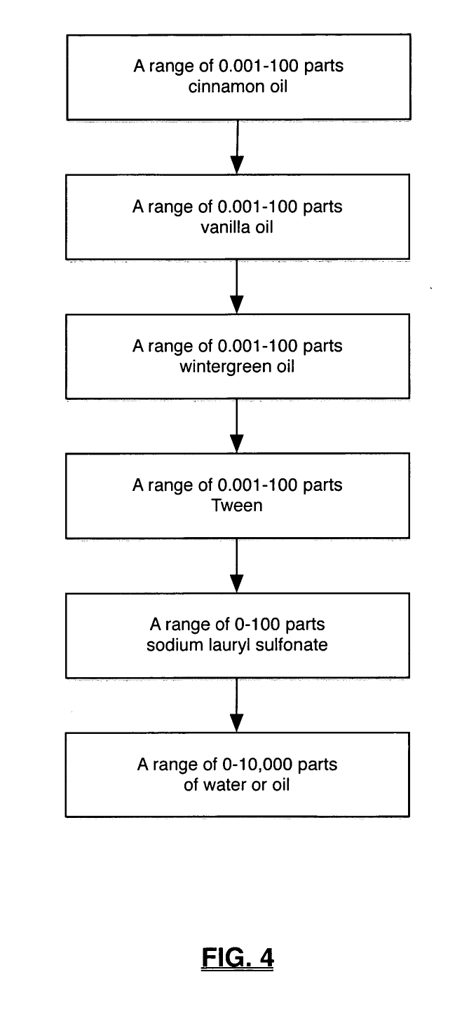

FIG. 5 is a flow of a preferred embodiment of the insect control and elimination composition encompassed by the present invention for use with insects generally, and ants, termites, grasshoppers and crickets specifically.

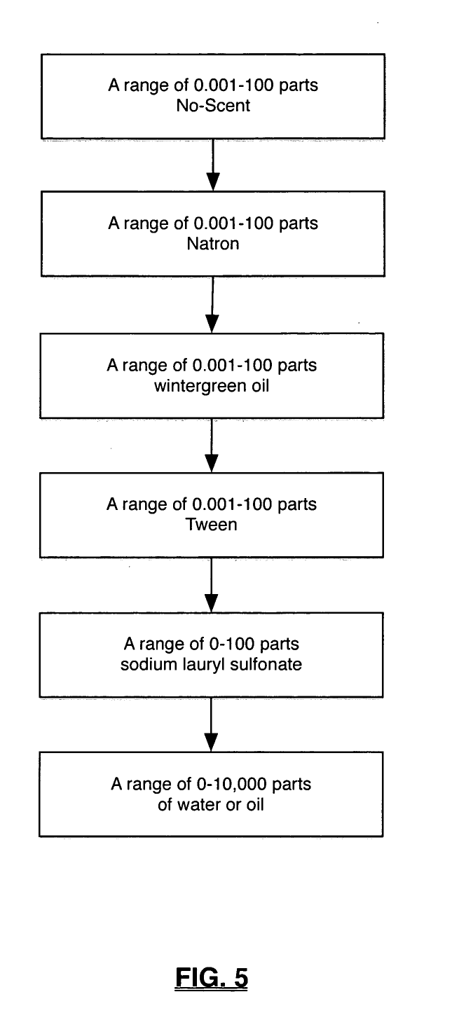

FIG. 6 is a flow chart of a preferred embodiment of the insect control and elimination composition encompassed by the present invention for use with insects generally, and wasps and bees specifically.

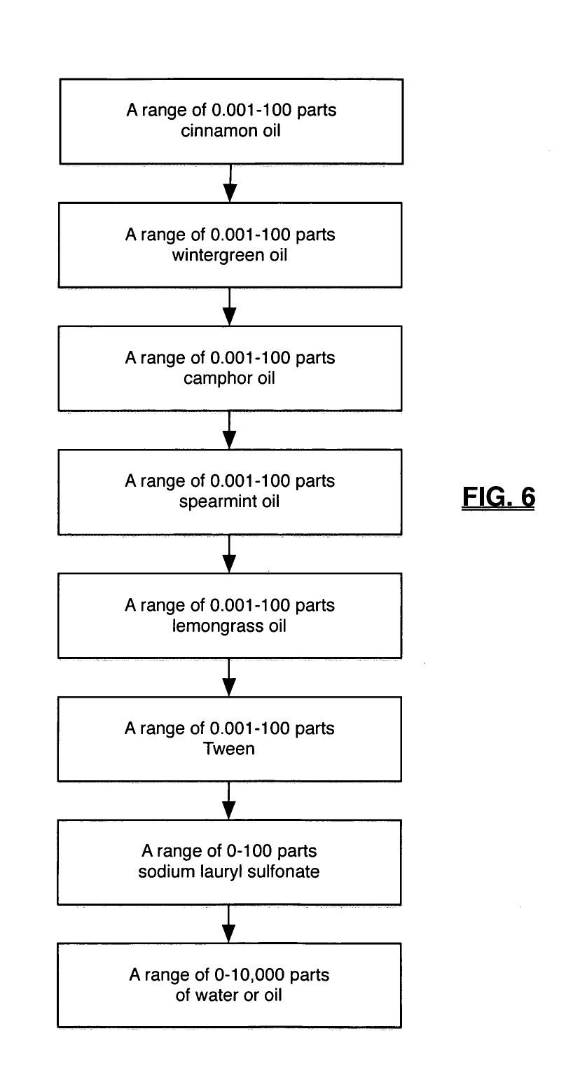

FIG. 7 is a flow chart of a preferred embodiment of the insect control and elimination composition encompassed by the present invention for use with insects generally, and specifically.

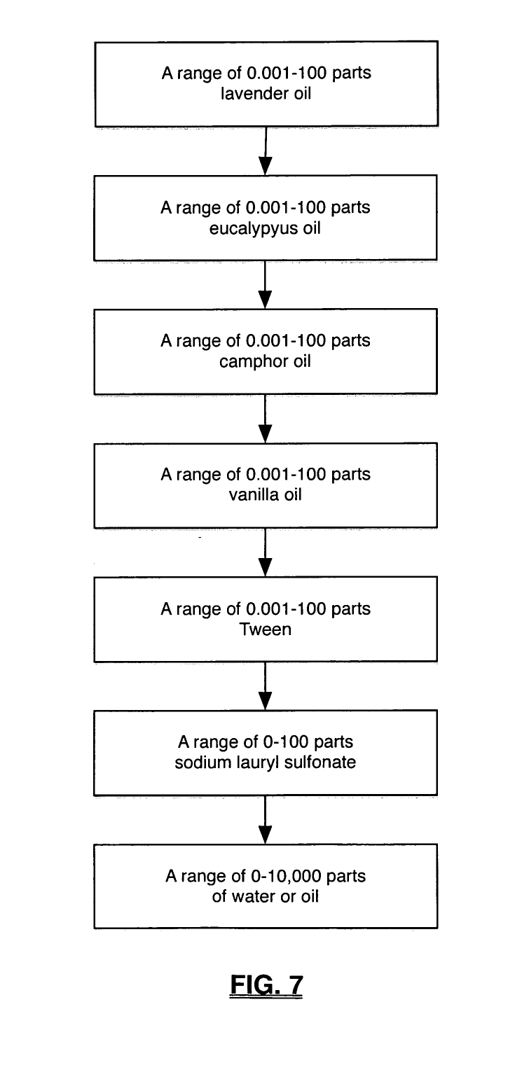

FIG. 8 is a flow chart of a preferred embodiment of the insect control and elimination composition encompassed by the present invention for use with insects generally, and mosquitoes specifically.

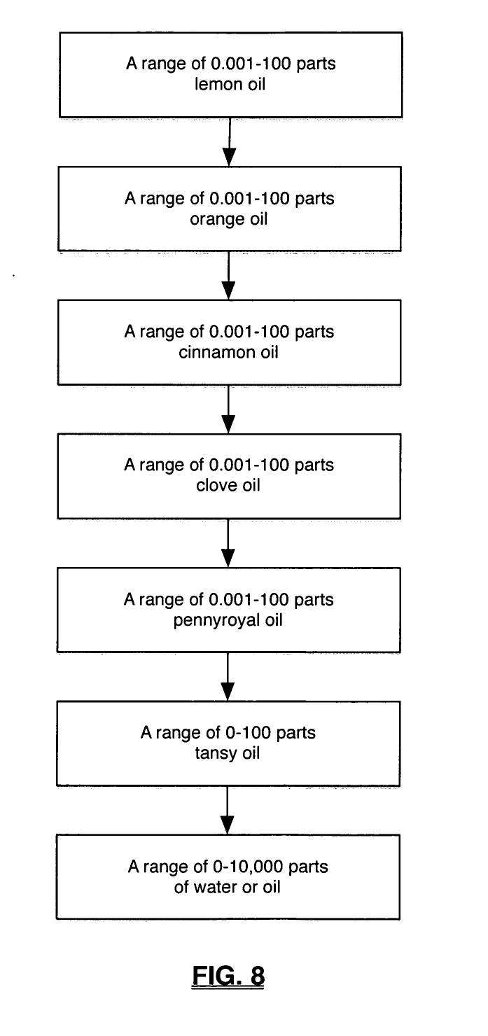

FIG. 9 is a flow chart of a preferred embodiment of the insect control and elimination composition encompassed by the present invention for use with insects generally, and spiders specifically.

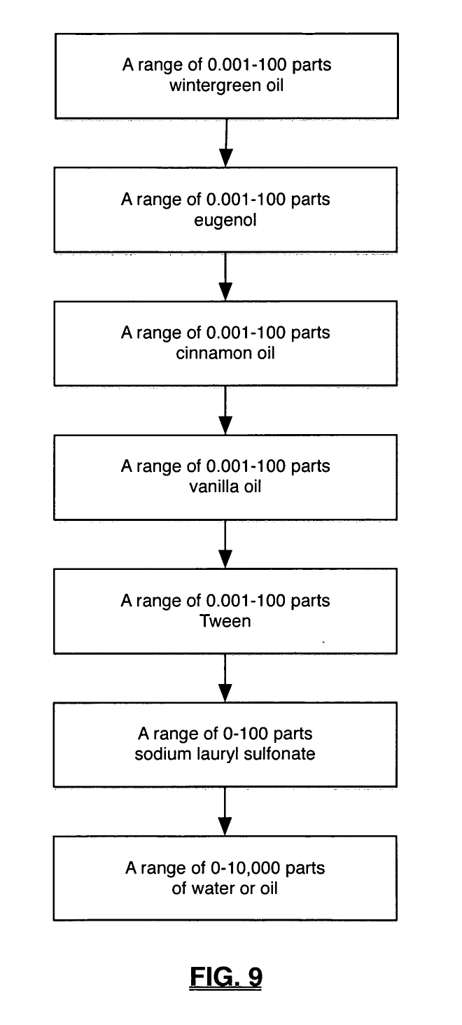

FIG. 10 is a flow chart of a preferred embodiment of the insect control and elimination composition encompassed by the present invention for use with insects generally, and fleas specifically.

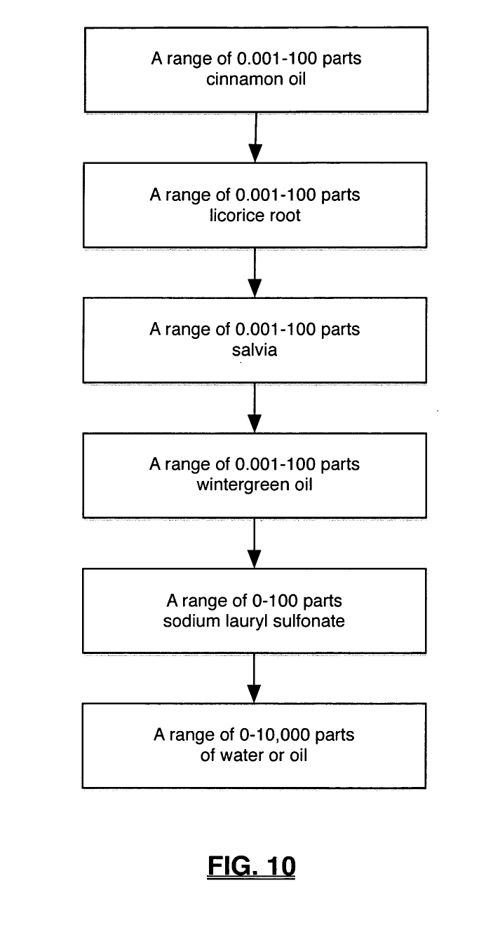

FIG. 11 is a flow chart of a preferred embodiment of the insect control and elimination composition encompassed by the present invention for use with insects generally.

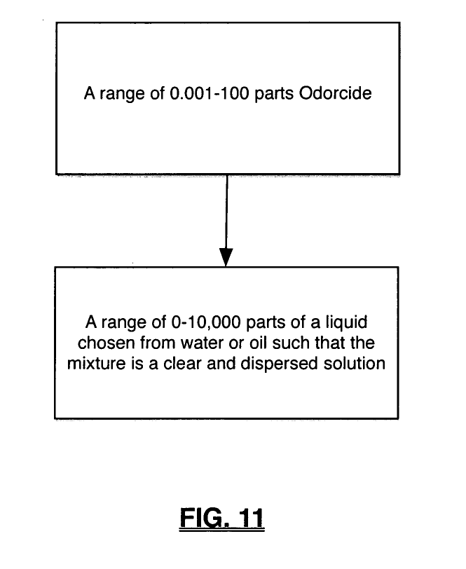

FIG. 12 is a flow chart of a preferred embodiment of the insect control and elimination composition encompassed by the present invention for use with insects generally.

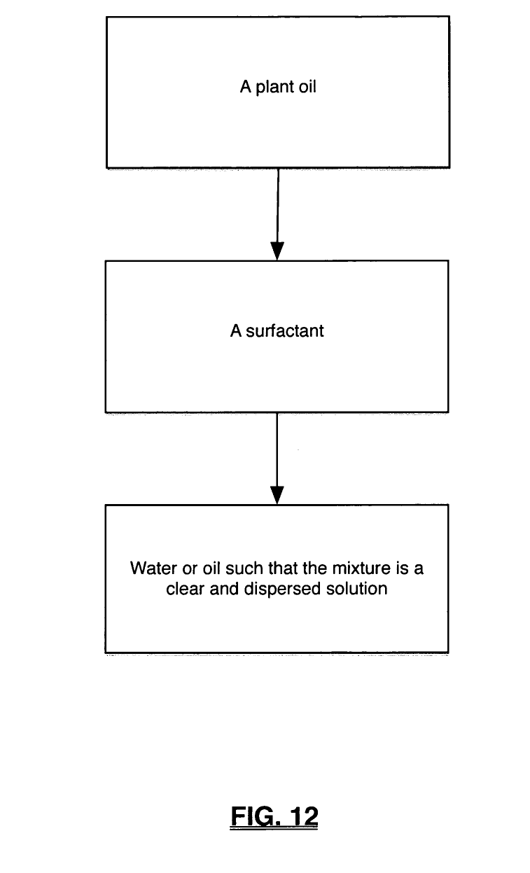

FIG. 13 is a flow chart of a preferred embodiment of the insect control and elimination composition encompassed by the present invention for use with insects generally.

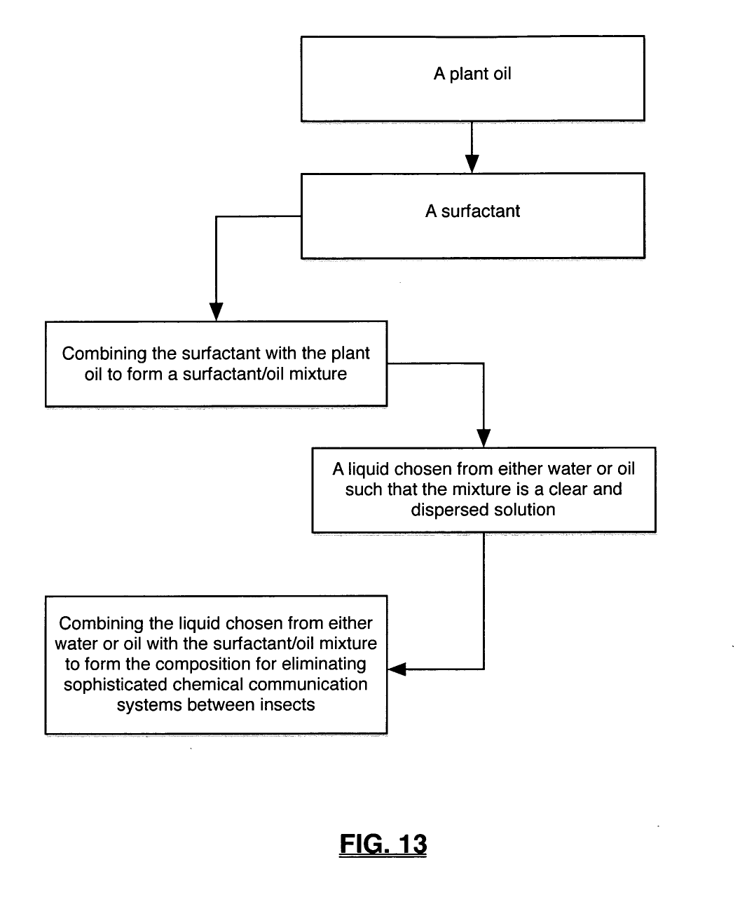

The above general description and the following detailed description are merely illustrative of the generic invention, and additional modes, advantages, and particulars of this invention will be readily suggested to those skilled in the art without departing from the spirit and scope of the invention.

### DETAILED DESCRIPTION OF THE PREFERRED EMBODIMENTS

Reference will now be made in detail to the present preferred embodiments of the invention as described in the accompanying drawings.

A method of eliminating sophisticated chemical communication system between and among inspects, especially where inspects live in functional social groups such as mounds swamps, nests, colonies, hives and other inter-dependent groups is disclosed.

An odor neutralizer is applied directly into or in near proximity of the social group. The odor neutralizer chemically eliminates and chemically modifies the sophisticated chemicals and pheromones the insects use to communicate and function as groups and individuals. A pheromone is a chemical secreted by an animal, especially an insect, that influences the behavior or development of others of the same species, i.e., a chemical substance that is usually produced by an animal and serves especially as a stimulus to other individuals of the same species for one or more behavioral responses.

The insects can no longer identify the chemical signals to search for food, identify food sources, identify “food trials,” identify group members, relocate back to the group, identify potential threats to the group, attract mates, reproduce, feed the queen and other group functions. Therefore, the social group or individual insect cannot function and is eliminated.

The odor neutralizer comprises natural products that are biodegradable, non-hazardous, environmentally safe, non-toxic and USDA accepted. The odor neutralizer is not a pesticide. It does not kill upon contact or by direct ingestion. The odor neutralizers are also anti-fungal and anti-bacterial.

The odor neutralizers selected in the present invention are commercially available natural plant oils. They are commonly produced for end use applications at garbage dumps, waste processing facilities, large animal stockyards, trash containers and industrial manufacturing plants where odors are a problem. They and are used as misted oils, hydro-dispersions or solids are placed in netted sleeves to counteract with these malodors in the air. These products are produced by several large and smaller companies and are known by such commercial names as Odorcide, Odor Control, Evane-Scent, and Fabreze. The main component in most of these products is natural essential oil chemical portion that reacts with the malodor as opposed to chemical deodorants that simply mask the odor. The distinction is the elimination of the odor of both components and no residual odor of each. In these instances the critical amount of odor control molecules must be at least 0.01% (See, U.S. Pat. Nos. 6,610,648 and 6,703,010)

These botanical oils are the volatile aromatic oils obtained by steam or hydrodistillation or extraction with water or alcohols. Different parts of the plants can be used to obtain essential oils, such as, but not limited to, flowers, leaves, seeds, roots, stems, bark, wood, and the like. Certain synthetic hydrocarbon volatile oils may serve to be cost effective and as effective as the natural oils.

Specific embodiments of the insect control and elimination method and composition of the present invention are listed below.

A composition for eliminating sophisticated chemical communication systems between insects, generally, resulting in the elimination of the insects comprises 1 part cinnamon oil, 1 part vanilla oil, 1 part wintergreen oil, 1 part licorice root oil, 1 part salvia oil, 0.5 parts sodium lauryl sulfonate, and 122 parts liquid chosen from the group of water and oil.

Another composition for eliminating sophisticated chemical communication systems between insects, generally, and ants and termites, specifically, resulting in the elimination of the insects comprises 1 part cinnamon oil, 1 part vanilla oil, 1 part wintergreen oil, 0.3 parts Tween, 0.3 parts sodium lauryl sulfonate, and a range of 125 parts liquid chosen from the group of water and oil.

Yet another composition for eliminating sophisticated chemical communication systems between insects, generally, and ants, termites grasshoppers and crickets, specifically, resulting in the elimination of the insects comprises 3 parts No-Scent, 3 parts Natron, 1 part wintergreen oil, 0.6 parts Tween, 0.6 parts sodium lauryl sulfonate, and 122 parts liquid chosen from the group of water and oil.

Yet still another composition for eliminating sophisticated chemical communication systems between insects, generally, and wasps and bees, specifically, resulting in the elimination of the insects comprises 1 part cinnamon oil, 1 part wintergreen oil, 1 part camphor oil, 1 part spearmint oil, 1 part lemongrass oil, 0.1 parts Tween, 0.1 parts sodium lauryl sulfonate, and 122 parts liquid chosen from the group of water and oil.

Another composition for eliminating sophisticated chemical communication systems between insects, generally, and mosquitoes, specifically, resulting in the elimination of the insects comprises a range of 1 part lavender oil, 1 part eucalyptus oil, 1 part camphor oil, 1 part vanilla oil, 0.1 parts Tween, 0.1 parts sodium lauryl sulfonate, and 122 parts liquid chosen from the group of water and oil.

Still another composition for eliminating sophisticated chemical communication systems between insects, generally, and mosquitoes, specifically, resulting in the elimination of the insects comprises 1 part lemon oil, 1 part orange oil, 1 part cinnamon oil, 1 part clove oil, 1 part pennyroyal oil, 0.1 part tansy oil, and 122 parts liquid chosen from the group of water and oil.

Yet still another composition for eliminating sophisticated chemical communication systems between insects, generally, and spiders, specifically, resulting in the elimination of the insects comprises 1 part wintergreen oil, 1 part eugenol, 1 part cinnamon oil, 1 part vanilla oil, 0.2 parts Tween, 0.2 parts sodium lauryl sulfonate, and 124 parts liquid chosen from the group of water and oil.

Still another composition for eliminating sophisticated chemical communication systems between insects, generally, and fleas, specifically, resulting in the elimination of the insects comprises 1 part cinnamon oil, 1 part licorice root, 1 part salvia, 1 part wintergreen oil, 0.6 parts sodium lauryl sulfonate, and 122 parts of a liquid chosen from the group of water and oil.

Yet another composition for eliminating sophisticated chemical communication systems between insects, generally, resulting in the elimination of the insects comprising a mixture of Odorcide and water or oil.

A composition for eliminating sophisticated chemical communication systems between insects, generally, resulting in the elimination of the insects comprising a mixture of a plant oil, a surfactant, and a liquid chosen from the group of water and oil such that the mixture is a clear and dispersed solution.

A composition for eliminating sophisticated chemical communication systems between insects, generally, resulting in the elimination of the insects comprising a mixture of a plant oil, a surfactant, and a liquid chosen from the group of water and oil such that the mixture is a clear and dispersed solution created by the steps of combining the surfactant with the plant oil to form a surfactant/oil mixture, and combining the liquid chosen from the group of water and oil with the surfactant/oil mixture to form the composition for eliminating sophisticated chemical communication systems between insects.

Additional advantages and modification will readily occur to those skilled in the art. The invention in its broader aspects is therefore not limited to the specific details, representative apparatus, and the illustrative examples shown and described herein. Accordingly, the departures may be made from the details without departing from the spirit or scope of the disclosed general inventive concept.

1. A method for the control and elimination of insects having sophisticated chemical communication odor systems and the insects tending to live in a group with specific insects performing specific functions within the group pursuant to the communication between and among the insects, the method comprising
(a) determining a plant oil that has a detrimental effect on the sophisticated chemical communication odor system of the insects to be controlled and eliminated,
(b) formulating an odor neutralizer comprising the selected plant oil,
(c) determining the total volume of odor neutralizer needed to react with the insect equivalent volume of communication chemicals in the insect group to be controlled and eliminated,
(d) applying the neutralizer to the insect group to be controlled such that the sophisticated chemical communication odor systems of the insects are destroyed, the insects are no longer able to communicate, the coordination between the insects is no longer possible, the insects cease to function as a group, and the group is eliminated.

2. A method for the control and elimination of insects having sophisticated chemical communication odor systems comprising
(a) determining a plant oil that has a detrimental effect on the sophisticated chemical communication odor system of the insect to be controlled and eliminated,
(b) formulating an odor neutralizer comprising the selected plant oil,
(c) determining at least 0.0001% by volume of the neutralizer per equivalent insect volume to react with the sophisticated communication chemicals associated with the insects, and
(d) applying the neutralizer to the insect to be controlled such that the sophisticated chemical communication odor systems of the insect is destroyed, the insect is no longer able to communicate, the coordination between the insect and other insects no longer possible, the insect ceases to function, and the insect is eliminated.

3. The method for the control and elimination of insects having sophisticated chemical communication odor systems as defined in claim 1 wherein the odor neutralizer comprises chemicals that interact with water.

4. The method for the control and elimination of insects having sophisticated chemical communication odor systems as defined in claim 1 wherein the insects comprise phylum Arthropods.

5. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts cinnamon oil,
(b) a range of 0.001-100 parts vanilla oil,
(c) a range of 0.001-100 parts wintergreen oil,
(d) a range of 0.001-100 parts licorice root oil,
(e) a range of 0.001-100 parts salvia oil,
(f) a range of 0-100 parts sodium lauryl sulfonate, and
(g) a range of 0-10,000 parts liquid chosen from the group of water and oil.

6. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts cinnamon oil,
(b) a range of 0.001-100 parts vanilla oil,
(c) a range of 0.001-100 parts wintergreen oil,
(d) a range of 0-100 parts Tween,
(e) a range of 0-100 parts sodium lauryl sulfonate, and
(f) a range of 0-10,000 parts liquid chosen from the group of water and oil.

7. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts No-Scent,
(b) a range of 0.001-100 parts Natron,
(c) a range of 0.001-100 parts wintergreen oil,
(d) a range of 0-100 parts Tween,
(e) a range of 0-100 parts sodium lauryl sulfonate, and
(f) a range of 0-10,000 parts liquid chosen from the group of water and oil.

8. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts cinnamon oil,
(b) a range of 0.001-100 parts wintergreen oil,
(c) a range of 0.001-100 parts camphor oil,
(d) a range of 0.001-100 parts spearmint oil,
(e) a range of 0.001-100 parts lemongrass oil,
(f) a range of 0-100 parts Tween,
(g) a range of 0-100 parts sodium lauryl sulfonate, and
(h) a range of 0-10,000 parts liquid chosen from the group of water and oil.

9. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts lavender oil,
(b) a range of 0.001-100 parts eucalyptus oil,
(c) a range of 0.001-100 parts camphor oil,
(d) a range of 0.001-100 parts vanilla oil,
(f) a range of 0-100 parts Tween,
(g) a range of 0-100 parts sodium lauryl sulfonate, and
(h) a range of 0-10,000 parts liquid chosen from the group of water and oil.

10. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts lemon oil,
(b) a range of 0.001-100 parts orange oil,
(c) a range of 0.001-100 parts cinnamon oil,
(d) a range of 0.001-100 parts clove oil,
(e) a range of 0.001-100 parts pennyroyal oil,
(f) a range of 0.001-100 parts tansy oil, and
(g) a range of 0-10,000 parts liquid chosen from the group of water and oil.

11. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts wintergreen oil,
(b) a range of 0.001-100 parts eugenol,
(c) a range of 0.001-100 parts cinnamon oil,
(d) a range of 0.001-100 parts vanilla oil,
(e) a range of 0-100 parts Tween,
(f) a range of 0-100 parts sodium lauryl sulfonate, and
(g) a range of 0-10,000 parts liquid chosen from the group of water and oil.

12. The method for eliminating sophisticated chemical communication systems between insects resulting in the elimination of the insects as defined in claim 16 wherein the step of blending an odor neutralizer with a plant oil to form a neutralizer-oil mixture further comprises the step of mixing:
(a) a range of 0.001-100 parts cinnamon oil,
(b) a range of 0.001-100 parts licorice root,
(e) a range of 0.001-100 parts salvia,
(d) a range of 0.001-100 parts wintergreen oil,
(e) a range of 0-100 parts sodium lauryl sulfonate, and
(g) a range of 0-10,000 parts of a liquid chosen from the group of water and oil.

13. The method for eliminating sophisticated chemical communication systems between insects resulting in the elimination of the insects as defined in claim 16 comprising a mixture of:
(a) a range of 0.001-100 parts Odorcide, and
(b) a range of 0-10,000 parts of a liquid chosen from the group of water and oil such that the mixture is a clear and dispersed solution.

14. The method for eliminating sophisticated chemical communication systems between insects resulting in the elimination of the insects as defined in claim 16 comprising a mixture of:
(a) the plant oil,
(b) a surfactant, and
(e) a liquid chosen from the group of water and oil such that the mixture is a clear and dispersed solution.

15. The method for eliminating sophisticated chemical communication systems between insects resulting in the elimination of the insects as defined in claim 16 comprising a mixture of:
(a) the plant oil,
(b) a surfactant, and
(c) a liquid chosen from the group of water and oil such that the mixture is a clear and dispersed solution created by the steps of:
(1) combining the surfactant with the plant oil to form a surfactant/oil mixture, and
(2) combining the liquid chosen from the group of water and oil with the surfactant/oil mixture to form the composition for eliminating sophisticated chemical communication systems between insects.

16. A method for eliminating sophisticated chemical communication systems between insects resulting in the elimination of the insects comprising the steps of:
(a) blending an odor neutralizer with a plant oil to form a neutralizer-oil mixture, and
(b) applying the neutralizer-oil mixture to the insect allowing the neutralizer-oil mixture to disrupt the sophisticated pheremone communications and functions used by the social insects.

17. The method for eliminating sophisticated chemical communication systems between insects resulting in the elimination of the insects defined in claim 16 wherein the plant oil is cinnamon oil.

18. The method for eliminating sophisticated chemical communication systems between insects resulting in the elimination of the insects as defined in claim 16 wherein the plant oil is grape oil.

19. The method for eliminating sophisticated chemical communication systems between insects resulting in the elimination of the insects as defined in claim 16 wherein the plant oil is wintergreen oil.

20. The method for eliminating sophisticated chemical communication systems between insects resulting in the elimination of the insects as defined in claim 16 wherein the plant oil is vanilla oil.

21. The method for eliminating sophisticated chemical communication systems between insects resulting in the elimination of the insects as defined in claim 16 wherein the plant oil is salvia oil.

22. The method for eliminating sophisticated chemical communication systems between insects resulting in the elimination of the insects as defined in claim 16 wherein the plant oil is spearmint oil.

23. The method for eliminating sophisticated chemical communication systems between insects resulting in the elimination of the insects as defined in claim 16 wherein the plant oil is lavender oil.

24. The method for eliminating sophisticated chemical communication systems between insects resulting in the elimination of the insects as defined in claim 16 wherein the plant oil is lemon grass oil.

25. The method for eliminating sophisticated chemical communication systems between insects resulting in the elimination of the insects as defined in claim 16 wherein the plant oil is lemon oil.

26. The method for eliminating sophisticated chemical communication systems between insects resulting in the elimination of the insects as defined in claim 16 wherein the plant oil is orange oil.

27. The method for eliminating sophisticated chemical communication systems between insects resulting in the elimination of the insects as defined in claim 16 wherein the plant oil is eucalyptus oil.

28. The method for eliminating sophisticated chemical communication systems between insects resulting in the elimination of the insects as defined in claim 16 wherein the plant oil is camphor oil.

29. The method for eliminating sophisticated chemical communication systems between insects resulting in the elimination of the insects as defined in claim 16 wherein the plant oil is clove oil.

30. The method for eliminating sophisticated chemical communication systems between insects resulting in the elimination of the insects as defined in claim 16 wherein the step of applying the neutralizer-oil mixture to the insect comprises engaging the insect with the neutralizer-oil mixture allowing the neutralizer-oil mixture to disrupt the sophisticated pheremone communications and functions used by the social insects.

31. The method for eliminating sophisticated chemical communication systems between insects resulting in the elimination of the insects as defined in claim 16 wherein the step of applying the neutralizer-oil mixture to the insect comprises engaging the nest of the insect with the neutralizer-oil mixture allowing the neutralizer-oil mixture to disrupt the sophisticated pheremone communications and functions used by the social insects.

32. The method for eliminating sophisticated chemical communication systems between insects resulting in the elimination of the insects as defined in claim 16 wherein the step of applying the neutralizer-oil mixture to the insect comprises engaging the environment in which the insect is found with the neutralizer-oil mixture allowing the neutralizer-oil mixture to disrupt the sophisticated pheremone communications and functions used by the social insects.
